(19) United States
(12) Patent Application Publication
(10) Pub. No.: US 2017/0312674 A1
(43) Pub. Date: Nov. 2, 2017

(54) SYSTEMS FOR THE PROCESSING OF COMPOUNDS

(71) Applicant: Massachusetts Institute of Technology, Cambridge, MA (US)

(72) Inventors: Allan Stuart Myerson, Boston, MA (US); Marcus O'Mahony, Cambridge, MA (US)

(73) Assignee: Massachusetts Institute of Technology, Cambridge, MA (US)

(21) Appl. No.: 15/372,124

(22) Filed: Dec. 7, 2016

Related U.S. Application Data
(60) Provisional application No. 62/264,741, filed on Dec. 8, 2015.

(51) Int. Cl. B01D 43/00; B01D 36/00

(52) U.S. Cl. CPC B01D 43/00; B01D 36/008

(57) ABSTRACT

The present disclosure is generally related to the separation of liquids from solids and for the recovery of solids and/or liquids from slurries. In some embodiments, liquids are separated from solids by applying a reduced pressure. In some embodiments, slurries are flowed by applying a pressure gradient. In some embodiments, an apparatus is provided that comprises a channel, an inlet, an outlet, and one or more ports. One or more ports may be constructed and arranged to apply a pressure differential and/or a reduced pressure to the channel. Such systems and methods may, in some embodiments, facilitate continuous manufacturing of solid products.

### RELATED APPLICATIONS

This application claims priority under 35 U.S.C. §119(e) to U.S. Provisional Patent Application Ser. No. 62/264,741, filed Dec. 8, 2015 and entitled “Systems for the Processing of Compounds,” which is incorporated herein by reference in its entirety for all purposes.

### GOVERNMENT SPONSORSHIP

This invention was made with Government support under Contract No. N66001-11-C-4147 awarded by the Space and Naval Warfare Systems Center. The Government has certain rights in the invention.

### FIELD

The present invention relates generally to systems and methods for separating liquids from solids and for recovering solids and/or liquids from slurries.

### BACKGROUND

Continuous flow processing of pharmaceuticals and fine chemicals promises significant benefits in terms of costs, safety and sustainability. However, significant processing bottlenecks related to the separation of liquids from solids and the processing of the resultant solids still exist.

Accordingly, improved compositions and methods are desirable.

### SUMMARY

Methods and articles for the separation of liquids from solids and for the recovery of solids and/or liquids from slurries as well as related compositions and methods associated therewith are provided. The subject matter of the present invention involves, in some cases, interrelated products, alternative solutions to a particular problem, and/or a plurality of different uses of one or more systems and/or articles.

In some embodiments, a method for at least partially separating liquid from solid in a slurry is provided. The method may comprise applying a reduced pressure to an upstream portion of a slurry, thereby reducing the liquid content of the upstream portion to at most 20 wt % and applying a pressure gradient across a region between the upstream portion and a downstream portion, thereby urging the slurry to flow in the downstream direction.

In some embodiments, an apparatus for recovering a solid from a slurry is provided. The apparatus may comprise a channel defining an upstream end and a downstream end, comprising an inlet for receiving a slurry, and an outlet positioned downstream of the inlet; first and second ports associated with the channel, the first port upstream of the second, and the first and second ports constructed and arranged to apply a pressure differential between them thereby urging a slurry in the channel to flow in a downstream direction; and a variable pressure port associated with the channel between the first and second ports, constructed and arranged to apply a reduced pressure to a slurry in the channel.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1A shows, in accordance with some embodiments, a schematic illustration of an apparatus comprising a channel, an inlet, an outlet, a first port, a second port, and a variable pressure port;

FIG. 1B shows, in accordance with some embodiments, a schematic illustration of an apparatus comprising a channel, an inlet, an outlet, a first port, a second port, a variable pressure port, and a washing liquid port;

FIG. 1C shows, in accordance with some embodiments, a schematic illustration of an apparatus comprising a channel, an inlet, an outlet, a first port, a second port, a variable pressure port, a third port, a fourth port, a dissolving liquid port, and a collection chamber;

FIG. 2 shows, in accordance with some embodiments, a schematic illustration of a method for removing a liquid from a slurry and flowing a slurry;

FIG. 3 shows, in accordance with some embodiments, a schematic illustration of an apparatus suitable for recovering a solid from a slurry;

FIG. 4 shows, in accordance with some embodiments, a schematic illustration of an apparatus suitable for recovering a solid from a slurry;

FIG. 5 shows, in accordance with some embodiments, a plot showing the water content of a slurry after undergoing drying.

### DETAILED DESCRIPTION

Inventive methods and articles for at least partially separating liquids from solids and/or for recovering solids from slurries are generally described. Certain embodiments relate to inventive apparatuses. In some embodiments, an apparatus comprises a channel, an inlet, an outlet, and at least three ports associated with the channel. The channel may define an upstream end and a downstream end. The first and second ports may be configured to apply a pressure differential between them, thereby urging a slurry in the channel to flow in a downstream direction. The third port may be a variable pressure port, and may be constructed and arranged to apply a reduced pressure to a slurry in the channel. In some embodiments, one or more of the apparatuses described herein may be advantageous for use in a continuous manufacturing process, such as a pharmaceutical continuous manufacturing process. For instance, an apparatus may be capable of easily connecting other modules within a continuous manufacturing system (e.g., by comprising standard fittings, by being configured to process chemicals at a similar rate, etc.), may be relatively small and/or lightweight, and/or may be configured to process chemicals in relatively small amounts.

Methods suitable for the separation of a liquid from a solid in a slurry are also provided. Some methods comprise applying a reduced pressure to an upstream portion of a slurry, thereby reducing the liquid content of the upstream portion to at most 20 wt %. In some embodiments, a pressure gradient may be applied across a slurry between an upstream portion and a downstream portion, thereby urging the slurry to flow in the downstream direction. In some embodiments, one or more of the methods described herein may be advantageous for use in a continuous manufacturing process, such as a pharmaceutical continuous manufacturing process. In some embodiments, a method may comprise flowing a slurry through any one of the apparatuses described herein.

As used herein, a slurry is a composition that contains a solid, typically a solid/liquid mixture or suspension. The slurry may essentially exclusively contain the solid (i.e., it may not contain any fluids), or it may contain the solid and a fluid (e.g., a liquid, a gas). The solid, which may comprise multiple species, is typically, but not always, particulate. In some, but not necessarily all, embodiments, a slurry may further comprise a liquid. In some such embodiments, the slurry may at least partially suspend and/or partially dissolve the solid. In some embodiments, at least a portion of the solid present in a slurry is not dissolved in any liquid component of the slurry.

As used herein, flowing a slurry refers to causing a slurry to translate. The slurry may translate in a downstream direction, or in any other direction. In some embodiments, a slurry comprises a sufficient amount of liquid that the slurry may flow due to liquid flow. In some embodiments, a slurry may not comprise sufficient liquid for liquid flow to occur. In some such embodiments, flowing a slurry may comprise granular flow, and/or translating at least a portion of the particles that make up the slurry.

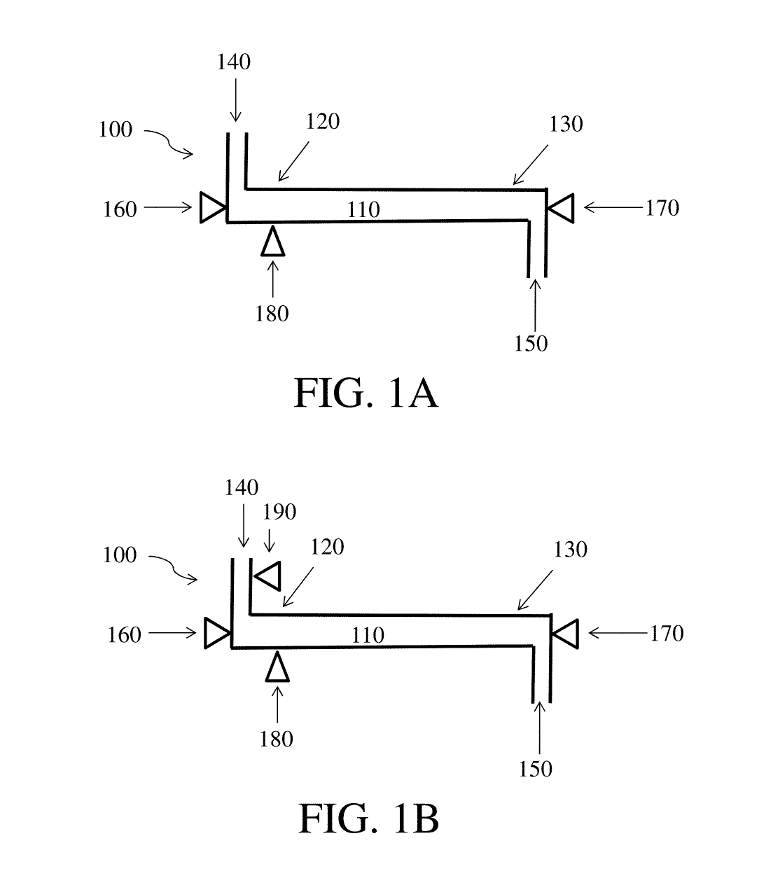

FIG. 1A depicts an apparatus 100 in accordance with certain embodiments of the invention. Apparatus 100 comprises channel 110 with upstream end 120, downstream end 130, inlet 140, and outlet 150. In some embodiments, the inlet may be capable of receiving a slurry. In some embodiments, the inlet is reversibly fluidically connected to an atmosphere outside the apparatus (i.e., a connection between the inlet and an atmosphere outside the apparatus can be reversibly established). In some embodiments, the inlet can be reversibly fluidically connected to an atmosphere outside the apparatus by actuating a valve (e.g., a ball valve). In some embodiments, the outlet is reversibly fluidically connected to an atmosphere outside the apparatus (i.e., a connection between the outlet and an atmosphere outside the apparatus can be reversibly established). In some embodiments, the outlet can be reversibly fluidically connected to an atmosphere outside the apparatus by actuating a valve (e.g., a ball valve).

It should be noted that while FIG. 1A shows a channel with an inlet that is positioned above the channel and an outlet that is positioned below the channel, other arrangements of the inlet and outlet with respect to the channel are also possible. For instance, either or both of the inlet and the outlet may be positioned at the same height of the channel, the inlet may be positioned below the channel, and/or the outlet may be positioned above the channel. The outlet is typically positioned downstream of the inlet.

Apparatus 100 also comprises first port 160, second port 170, and variable pressure port 180. In some embodiments, the first port and the second port may each be capable of applying a pressure to at least a portion of the channel. That is, in some embodiments the first and second ports may be constructed and arranged to apply a pressure differential between them. As an example, the first port may be capable of applying a first pressure to the upstream end of the channel and the second port may be capable of applying a second pressure to the downstream end of the channel. If the first port applies the first pressure simultaneously to the second port applying the second pressure, a pressure differential may be established across the channel. The pressure differential may be such that the pressure is higher at the upstream end of the channel than at the downstream end, or higher at the downstream end of the channel than at the upstream end. In some embodiments, the pressure differential may urge a slurry in the channel to flow (e.g., in a downstream direction).

In some embodiments, the variable pressure port may be capable of applying (i.e., constructed and arranged to apply) a reduced pressure to at least a portion (e.g., the upstream end) or all of the channel and/or to at least a portion of a slurry in the channel (e.g., the upstream portion). Suitable values of reduced pressure will be described further below.

It should be noted that although the first port is shown in FIG. 1A as upstream of the second port, other arrangements of the first port with respect to the second port are also possible (e.g., the first port may be positioned downstream of the second port, or the first port may be positioned neither upstream nor downstream of the second port). Similarly, although the variable pressure port is shown to be positioned between the first port and the second port and proximate the upstream end of the channel, the variable pressure port may be positioned anywhere within the channel (e.g., proximate the downstream end of the channel, proximate neither the upstream end nor the downstream end of the channel, positioned upstream of both the first port and the second port, positioned downstream of both the first port and the second port, etc.). Additionally, the apparatus may comprise more than three ports. For example, the apparatus may further comprise a third port, a fourth port, a fifth port, or even more ports.

In some embodiments, a filter or filter(s) may be disposed on one or more of the ports (e.g., the first port, the second port, the variable pressure port, the third port if present, the fourth port if present). The filter or filters may be constructed and arranged to remove any liquid described herein from the slurry. In some embodiments, the filter or filter(s) may allow liquid transport but not solid transport. In some embodiments, the filter or filter(s) may block transport of solids with an average diameter of greater than or equal to 1 micron, but allow the transport of solids with smaller diameters, liquids, and gases. In some embodiments, the channel may comprise at least one filter, at least two filters, at least three filters, or even more filters.

In some embodiments, an apparatus as described herein may comprise one or more additional components, as will be described in further detail below. It should be understood that the apparatus may comprise none of the additional components, only one of the additional components, all of the additional components, or any subset of the additional components.

One example of an optional additional component is shown in FIG. 1B. In FIG. 1B, apparatus 100 further comprises washing liquid port 190. The washing liquid port is constructed and arranged to allow a washing liquid to be introduced into the channel. In some embodiments, the apparatus further comprises a filter constructed and arranged to remove the washing liquid from the slurry. A washing liquid is typically a liquid that does not dissolve any solids that may be present in the channel. Further examples of washing liquids will be described in more detail below.

Other examples of optional additional components are shown in FIG. 1C. FIG. 1C shows apparatus 100 further comprising components suitable for the collection of solids from the channel, including collection chamber 210, third port 220, fourth port 230, and dissolving liquid port 240. Although the collection chamber is depicted without an outlet, it should be understood that some embodiments that comprise a collection chamber further comprise an outlet to the collection chamber. In some embodiments, the collection chamber may be in fluidic communication with the channel (e.g., the collection chamber may be in fluidic communication with the outlet of the channel). The collection chamber may be in permanent fluidic communication with the channel (i.e., it cannot be taken out of fluidic communication with the channel), or it may be in reversible fluidic communication with the channel (i.e., it can be reversibly switched from being in fluidic communication with the channel to not being in fluidic communication with the channel). For example, the collection chamber may be separated from the channel by a valve that is capable of being reversibly opened and closed.

In some embodiments, the third port and the fourth port may each be capable of applying a pressure to at least a portion of the channel and/or to at least a portion of collection chamber 210. For instance, the third port may be capable of applying a third pressure to the downstream end of the channel and the fourth port may be capable of applying a fourth pressure to the collection chamber. If the third port applies the third pressure simultaneously to the fourth port applying the fourth pressure, a pressure differential may be established across the channel. If the pressure is higher in the channel than in the chamber (e.g., if the third port applies a positive pressure and the fourth port applies a reduced pressure), material that is present in the channel proximate the collection chamber may be transferred into the collection chamber under the influence of the pressure gradient.

In some embodiments, the collection chamber may comprise a fourth port and the fourth port may be a variable pressure port (i.e., a second variable pressure port may be associated with the collection chamber).

In some embodiments, the dissolving liquid port may be capable of introducing a dissolving liquid into the collection chamber. A dissolving liquid may be capable of dissolving at least a portion of any solids present in the collection chamber, and/or may be capable of suspending at least a portion of any solids present in the collection chamber. Further discussion of dissolving liquids will be presented below.

As described above, certain embodiments relate to inventive methods. In some, but not necessarily all, embodiments, methods described herein may take place in an apparatus as described above.

Methods described herein may be used to recover a liquid component of a slurry and/or a solid component of a slurry. That is, in some embodiments, a liquid may be recovered as a product and in some embodiments a solid is recovered as a product. In some embodiments, both a liquid and a solid may be recovered.

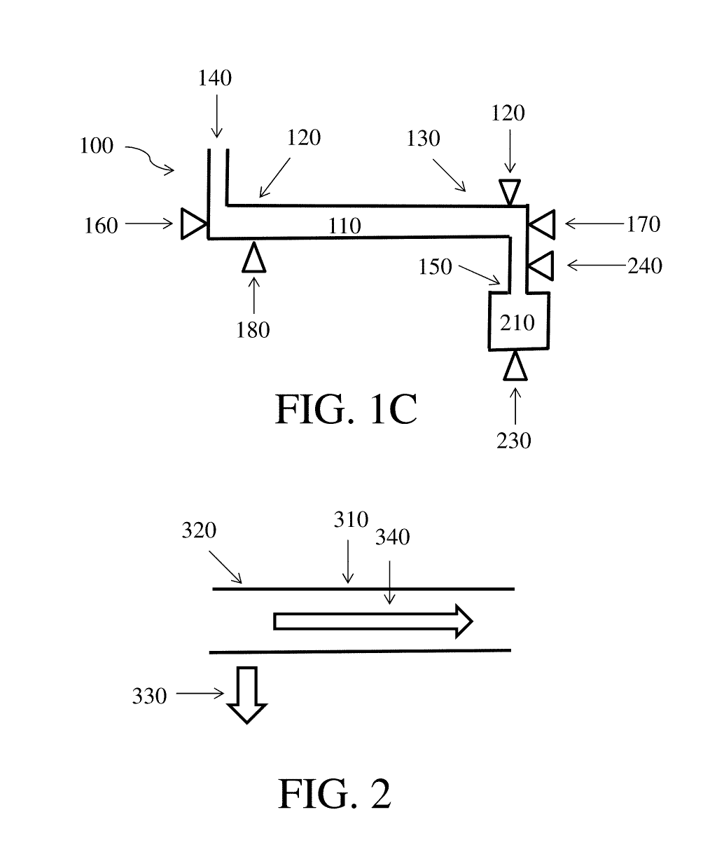

FIG. 2 shows one example of a method, where reduced pressure 330 is applied to upstream portion 320 of slurry 310. Application of the reduced pressure may cause the liquid content of the slurry to be reduced. The reduced pressure may cause the liquid to at least partially evaporate and/or may cause the liquid to flow but not the solid. For example, applying a reduced pressure (e.g., by a port) may cause the liquid to flow through a filter (e.g., a filter covering the port) that is impermeable to the solid. In this manner, the filter may serve as a sieve that separates the liquid from the solid. FIG. 2 also shows the application of pressure gradient 330 to slurry 310. Applying the pressure gradient may cause the slurry to flow in a downstream direction.

In some embodiments, a slurry as described herein may undergo one or more additional steps prior to, simultaneous to, and/or after being subject to the method shown in FIG. 2 (e.g., a washing step or steps as described below, a dissolving step or steps as described below). In some embodiments, an additional step may be present in between the step of applying reduced pressure and the step of applying a pressure gradient (it should also be noted that applying a reduced pressure and applying a pressure gradient may occur sequentially, in either order, or simultaneously). It should be understood that the method may comprise none of the additional steps, only one of the additional steps, all of the additional steps, or any subset of the additional steps.

The slurry may be in any suitable form before or after it has undergone one or more of the method steps described above and herein (e.g., exposure to reduced pressure, flowing under the influence of a pressure gradient, undergoing a washing step or steps as described below, undergoing a dissolving step or steps as described below). In some embodiments, the slurry is in the form of a cake after it has undergone one or more of the method steps described above and herein. In some embodiments, the slurry is in the form of a cake at the conclusion of a method.

In some embodiments, the slurry contains at most 20 wt % of the liquid after it has undergone one or more of the method steps described above and herein, at most 15 wt % of the liquid after it has undergone one or more of the method steps described above and herein, at most 10 wt % of the liquid after it has undergone one or more of the method steps described above and herein, at most 5 wt % of the liquid after it has undergone one or more of the method steps described above and herein, at most 2.5 wt % of the liquid after it has undergone one or more of the method steps described above and herein, or at most 1 wt % of the liquid after it has undergone one or more of the method steps described above and herein. In some embodiments, the slurry contains at least 0 wt % of the liquid after it has after it has undergone one or more of the method steps described above and herein, at least 1 wt % of the liquid after it has undergone one or more of the method steps described above and herein, at least 2.5 wt % of the liquid after it has undergone one or more of the method steps described above and herein, at least 5 wt % of the liquid after it has undergone one or more of the method steps described above and herein, at least 10 wt % of the liquid after it has undergone one or more of the method steps described above and herein, or at least 15 wt % of the liquid after it has undergone one or more of the method steps described above and herein. Combinations of the above-referenced ranges are also possible (e.g., at least 0 wt % of the liquid and at most 20 wt % of the liquid). Other ranges are also possible.

In some embodiments, the slurry may contain at least 5 wt % of solids prior to undergoing one or more of the method steps described above and herein, at least 10 wt % of solids prior to undergoing one or more of the method steps described above and herein, or at least 15 wt % of solids prior to undergoing one or more of the method steps described above and herein, at least 20 wt % of solids prior to undergoing one or more of the method steps described above and herein, or at least 25 wt % of solids prior to undergoing one or more of the method steps described above and herein. In some embodiments, the slurry may contain at most 30 wt % of the solids prior to undergoing one or more of the method steps described above and herein, at most 25 wt % of the solids prior to undergoing one or more of the method steps described above and herein, at most 20 wt % of the solids prior to undergoing one or more of the method steps described above and herein, at most 15 wt % of the solids prior to undergoing one or more of the method steps described above and herein, or at most 10 wt % of the solids prior to undergoing one or more of the method steps described above and herein. Combinations of the above-referenced ranges are also possible (e.g., at least 5 wt % and at most 30 wt %, or at least 5 wt % and at most 15 wt %). Other ranges are also possible.

In some embodiments, the liquid may be removed from the slurry without the application of heat. For example, the application of reduced pressure alone, or the application reduced pressure in combination with other non-thermal treatments may cause the liquid to be removed. In some embodiments, heat may be applied to the slurry to cause liquid removal. Heat application may comprise exposing the slurry to a heated air flow while the slurry is exposed to reduced pressure and/or applying heat to the slurry as it passes through a filter. Other methods of applying heat are also possible.

In some embodiments, a method may comprise a washing step or step. Washing a slurry may comprise exposing the slurry to a washing liquid. The washing liquid may be exposed to the slurry by any suitable means, such as by flowing into and/or over the slurry.

In many, but not necessarily all, embodiments, the washing liquid may be removed from the slurry. For example, the liquid may be caused to separate from the slurry under the influence of reduced pressure. The reduced pressure may cause the washing liquid to at least partially evaporate and/or may cause the washing liquid to flow but not the solid. For example, applying a reduced pressure (e.g., by a port) may cause the washing liquid to flow through a filter (e.g., a filter covering the port) that is impermeable to the solid. In this manner, the filter may serve as a sieve that separates the washing liquid from the solid.

In some embodiments, the slurry contains at most 20 wt % of the washing liquid after it has been washed, at most 15 wt % of the washing liquid after it has been washed, at most 10 wt % of the washing liquid after it has been washed, at most 5 wt % of the washing liquid after 30 it has been washed, at most 2.5 wt % of the washing liquid after it has been washed, or at most 1 wt % of the washing liquid after it has been washed. In some embodiments, the slurry contains at least 0 wt % of the washing liquid after it has been washed, at least 1 wt % of the washing liquid after it has been washed, at least 2.5 wt % of the washing liquid after it has been washed, at least 5 wt % of the washing liquid after it has been washed, at least 10 wt % of the washing liquid after it has been washed, or at least 15 wt % of the washing liquid after it has been washed. Combinations of the above-referenced ranges are also possible (e.g., at least 0 wt % of the liquid and at most 20 wt % of the liquid). Other ranges are also possible.

In some embodiments, the slurry may be washed, and the washing step may occur in any suitable order with respect to other method steps. In some embodiments, the slurry may be washed prior to undergoing any other method steps. In some embodiments, the slurry may be washed after the liquid content of the slurry has been reduced but before a pressure gradient has been applied to the slurry. In some embodiments, the slurry may be washed after both the liquid content of the slurry has been reduced but before a pressure gradient has been applied to the slurry. Slurry washing may also occur prior to, between, and/or after any other method steps.

In some embodiments, a method may comprise a collecting step or step. Collecting a slurry may comprise introducing the slurry to a collection chamber. This can be accomplished by any suitable method. In some embodiments, a slurry is introduced into a collection chamber by applying a pressure gradient to the slurry such that it flows into the collection chamber. In some such embodiments, the slurry introduced into the collection chamber may be partially or substantially dry (e.g., it may contain at least 80 wt % or at least 95 wt % solids), may comprise a solid cake, and/or may comprise loose solid particles.

In some embodiments, collecting the slurry may comprise exposing the slurry to a source of reduced pressure. Exposing the slurry to the source of reduced pressure may further reduce the liquid content of the slurry.

In some embodiments, collecting a slurry may comprise exposing the slurry to a dissolving liquid. The dissolving liquid may dissolve at least a portion of the solids within the slurry. The dissolving liquid may be any suitable liquid, examples of which will be described below. Without wishing to be bound by theory, it is believed that dissolving the slurry in the dissolving liquid may allow it to be more easily transported between modules within a continuous manufacturing system.

In some embodiments, the slurry may be collected, and the collection step may occur in any suitable order with respect to other method steps. The slurry is typically, but not always, collected after its liquid content has been reduced and after it has been caused to flow in a downstream direction. In some embodiments, the slurry may be collected prior to a final washing step.

As described above, certain inventive methods relate to the application of a pressure differential to the slurry and certain inventive apparatuses may be configured to apply a pressure differential to a slurry. In some embodiments, a pressure differential (e.g., between an upstream portion of the slurry and a downstream portion of the slurry, between a first port and a second port, between a channel and a collection chamber, between a third port and a fourth port) may be greater than or equal to 0.1 atm, greater than or equal to 0.2 atm, greater than or equal to 0.5 atm, greater than or equal to 1 atm, greater than or equal to 2 atm, or greater than or equal to 5 atm. In some embodiments, a pressure differential may be less than or equal to 10 atm, less than or equal to 5 atm, less than or equal to 2 atm, less than or equal to 1 atm, less than or equal to 0.5 atm, or less than or equal to 0.2 atm. Combinations of the above-referenced ranges are also possible (e.g., greater than or equal to 0.1 atm and less than or equal to 10 atm). Other ranges are also possible.

In some embodiments, a reduced pressure may be applied by one or more ports (e.g., a second port, a fourth port, a variable pressure port) and/or may be applied to one or more portions of the slurry (e.g., an upstream portion, a downstream portion). In some embodiments, applying a reduced pressure may comprise exposing the port or portion of the slurry to a source of vacuum. As used herein, the pressure applied is considered to be the value of pressure at the point of application (i.e., the application of pressures below 1 atm comprise forming a pressure of less than atmospheric pressure at the point of application and the application of pressures above 1 atm comprise forming a pressure of greater than atmospheric pressure at the point of application). In some embodiments, the reduced pressure may be greater than or equal to 0.1 atm, greater than or equal to 0.2 atm, greater than or equal to 0.3 atm, greater than or equal to 0.4 atm, or greater than or equal to 0.5 atm. In some embodiments, the reduced pressure may be less than or equal to 0.5 atm, less than or equal to 0.4 atm, less than or equal to 0.3 atm, or less than or equal to 0.2 atm. Combinations of the above-referenced ranges are also possible (e.g., greater than or equal to 0.1 atm and less than or equal to 0.5 atm). Other ranges are also possible.

In some embodiments, a positive pressure may be applied by one or more ports (e.g., a first port, a third port) and/or may be applied to one or more portions of the slurry (e.g., an upstream portion, a downstream portion). In some embodiments, applying a positive pressure may comprise exposing the port or portion of the slurry to a source of gas. Non-limiting examples of suitable gases include inert gases (e.g., nitrogen) and air. In some embodiments, the positive pressure may be greater than or equal to 1 atm, greater than or equal to 2 atm, or greater than or equal to 5 atm. In some embodiments, the positive pressure may be less than or equal to 10 atm, less than or equal to 5 atm, or less than or equal to 2 atm. Combinations of the above-referenced ranges are also possible (e.g., greater than or equal to 1 atm and less than or equal to 10 atm). Other ranges are also possible.

As described above, certain inventive embodiments relate to slurries that comprise a solid. The solid may comprise one species, or may comprise multiple species. In some embodiments, the solid is a crystalline solid.

In some embodiments, the solid may comprise an active pharmaceutical ingredient (“API”). As used herein, the term “active pharmaceutical ingredient” (also referred to as a “drug”) refers to an agent that is administered to a subject to treat a disease, disorder, or other clinically recognized condition, or for prophylactic purposes, and has a clinically significant effect on the body of the subject to treat and/or prevent the disease, disorder, or condition. Active pharmaceutical ingredients include, without limitation, agents listed in the United States Pharmacopeia (USP), Goodman and Gilman's The Pharmacological Basis of Therapeutics, 10th Ed., McGraw Hill, 2001; Katzung, B. (ed.) Basic and Clinical Pharmacology, McGraw-Hill/Appleton & Lange, 8th edition (Sep. 21, 2000); Physician's Desk Reference (Thomson Publishing); and/or The Merck Manual of Diagnosis and Therapy, 17th ed. (1999), or the 18th ed (2006) following its publication, Mark H. Beers and Robert Berkow (eds.), Merck Publishing Group, or, in the case of animals, The Merck Veterinary Manual, 9th ed., Kahn, C. A. (ed.), Merck Publishing Group, 2005. Preferably, though not necessarily, the active pharmaceutical ingredient is one that has already been deemed safe and effective for use in humans or animals by the appropriate governmental agency or regulatory body. For example, drugs approved for human use are listed by the FDA under 21 C.F.R. §§330.5, 331 through 361, and 440 through 460, incorporated herein by reference; drugs for veterinary use are listed by the FDA under 21 C.F.R. §§500 through 589, incorporated herein by reference. All listed drugs are considered acceptable for use in accordance with the present invention.

In some examples, the solid may comprise an API and the API may be one or more of fenofibrate, etomidate, ciprofloxacin hydrochloride, rufinamide, artemisinin, imatinib, efavirenz, nabumetone, pregabalin, tamoxifen, diphenhydramine hydrochloride, lidocaine hydrochloride, diazepam, fluoxetine hydrochloride.

As described above, certain inventive embodiments relate to slurries that comprise a liquid. The liquid may comprise one species, or may comprise multiple species. In some embodiments, the liquid may be a nonsolvent for the solid (i.e., it may not dissolve the solid, or the maximum solubility of the solid in the nonsolvent may be less than 1 wt %). In some embodiments, the liquid may comprise an organic solvent, such as acetone, ethanol, methanol propanol, ethyl ether, dichloromethane, hexane, heptane, methyl ethyl ketone, and chloroform. In some embodiments, the liquid may be water, may comprise water, and/or may comprise an aqueous solvent (e.g., a solvent that comprises water and one or more species dissolved in water).

In some embodiments, the liquid has a low boiling point. For example, the boiling point of the liquid may be less than or equal to 100° C., less than or equal to 90° C., less than or equal to 80° C., less than or equal to 70° C., less than or equal to 60° C., less than or equal to 50° C., less than or equal to 40° C., or less than or equal to 30° C. In some embodiments, the boiling point of the liquid may be greater than or equal to 25° C., greater than or equal to 30° C., greater than or equal to 40° C., greater than or equal to 50° C., greater than or equal to 60° C., greater than or equal to 70° C., greater than or equal to 80° C., or greater than or equal to 90° C. Combinations of the above-referenced ranges are also possible (e.g., greater than or equal to 25° C. and less than or equal to 100° C.). Other ranges are also possible.

In some embodiments, the liquid may have a high vapor pressure at 20° C. In some embodiments, the liquid may have a vapor pressure of greater than or equal to 2 kPa, greater than or equal to 5 kPa, greater than or equal to 10 kPa, greater than or equal to 20 kPa, or greater than or equal to 50 kPa at 20° C. In some embodiments, the liquid may have a vapor pressure of less than or equal to 80 kPa, less than or equal to 50 kPa, less than or equal to 20 kPa, less than or equal to 10 kPa, or less than or equal to 5 kPa at 20° C. Combinations of the above-referenced ranges are also possible (e.g., greater than or equal to 2 kPa and less than or equal to 80 kPa). Other ranges are also possible.

In some embodiments, an apparatus as described herein may comprise a port constructed and arranged to allow a washing liquid to be introduced into the channel and/or a method may comprise exposing a slurry to a washing liquid. In some embodiments, the washing liquid may be a nonsolvent for the solid (i.e., it may not dissolve the solid, or the maximum solubility of the solid in the nonsolvent may be less than 1 wt %). In some embodiments, the liquid may comprise an organic solvent, such as acetone, ethanol, methanol propanol, ethyl ether, dichloromethane, hexane, heptane, methyl ethyl ketone, and chloroform. In some embodiments, the liquid may be water, may comprise water, and/or may comprise an aqueous solvent (e.g., a solvent that comprises water and one or more species dissolved in water).

In some embodiments, the washing liquid has a low boiling point. For example, the boiling point of the washing liquid may be less than or equal to 100° C., less than or equal to 90° C., less than or equal to 80° C., less than or equal to 70° C., less than or equal to 60° C., less than or equal to 50° C., less than or equal to 40° C., or less than or equal to 30° C. In some embodiments, the boiling point of the washing liquid may be greater than or equal to 25° C., greater than or equal to 30° C., greater than or equal to 40° C., greater than or equal to 50° C., greater than or equal to 60° C., greater than or equal to 70° C., greater than or equal to 80° C., or greater than or equal to 90° C. Combinations of the above-referenced ranges are also possible (e.g., greater than or equal to 25° C. and less than or equal to 100° C.). Other ranges are also possible.

In some embodiments, the washing liquid may have a high vapor pressure at room temperature. In some embodiments, the washing liquid may have a vapor pressure of greater than or equal to 2 kPa, greater than or equal to 5 kPa, greater than or equal to 10 kPa, greater than or equal to 20 kPa, or greater than or equal to 50 kPa at 20° C. In some embodiments, the washing liquid may have a vapor pressure of less than or equal to 80 kPa, less than or equal to 50 kPa, less than or equal to 20 kPa, less than or equal to 10 kPa, or less than or equal to 5 kPa at 20° C. Combinations of the above-referenced ranges are also possible (e.g., greater than or equal to 2 kPa and less than or equal to 80 kPa). Other ranges are also possible.

In some embodiments, an apparatus as described herein may comprise a port constructed and arranged to allow a dissolving liquid to be introduced into the channel and/or a method may comprise exposing a slurry to a dissolving liquid. In some embodiments, the dissolving liquid may be a solvent for the solid (i.e., it may dissolve all or at least a portion of the solid). Appropriate dissolving liquids may be selected by exposing the solid to the candidate dissolving liquids under conditions that mimic those in the collection chamber (e.g., temperature, exposure time, ratio of dissolving liquid to solid) and determining whether a sufficient quantity of the solid (e.g., at least 5 wt %, at least 25 wt %, at least 50 wt %, or at least 90 wt % of the solid) dissolves in the dissolving liquid. Candidate dissolving liquids that dissolve a sufficient quantity of solid are suitable for use herein.

In some embodiments, one or more components of the apparatus as described herein may be relatively small. For instance, the apparatus may be configured to operate at miniplant scale, and/or may be configured for desktop operation.

In some embodiments, the channel may have a total volume of less than or equal to 1000 cm³, less than or equal to 500 cm³, less than or equal to 200 cm³, or less than or equal to 100 cm³. In some embodiments, the channel may have a total volume of greater than or equal to 50 cm³, greater than or equal to 100 cm³, greater than or equal to 200 cm³, or greater than or equal to 500 cm³. Combinations of the above-referenced ranges are also possible (e.g., greater than or equal to 50 cm³ and less than or equal to 1000 cm³). Other ranges are also possible.

In some embodiments, the entire apparatus may have a total volume of less than or equal to 1000 cm³, less than or equal to 500 cm³, less than or equal to 200 cm³, or less than or equal to 100 cm³. In some embodiments, the entire apparatus may have a total volume of greater than or equal to 50 cm³, greater than or equal to 100 cm³, greater than or equal to 200 cm³, or greater than or equal to 500 cm³. Combinations of the above-referenced ranges are also possible (e.g., greater than or equal to 50 cm³ and less than or equal to 1000 cm³). Other ranges are also possible.

In some embodiments, an apparatus may be configured and/or a method may be performed such that a relatively low amount of slurry is processed over the course of a day. For example, the slurry may be transferred through the channel at a rate of less than or equal to 1000 g/day, less than or equal to 500 g/day, less than or equal to 200 g/day, less than or equal to 100 g/day, less than or equal to 50 g/day, or less than or equal to 20 g/day. In some embodiments, the slurry may be transferred through the channel at a rate of greater than or equal to 10 g/day, greater than or equal to 20 g/day, greater than or equal to 50 g/day, greater than or equal to 100 g/day, greater than or equal to 200 g/day, or greater than or equal to 500 g/day. Combinations of the above-referenced ranges are also possible (e.g., greater than or equal to 10 g/day and less than or equal to 1000 g/day). Other ranges are also possible.

In some embodiments, an apparatus may be configured and/or a method may be performed such that the slurry is processed relatively rapidly. In some embodiments, the method may occur over a period of less than or equal to 30 minutes, less than or equal to 20 minutes, or less than or equal to 10 minutes. In some embodiments, the method may occur over a period of time of greater than or equal to 5 minutes, greater than or equal to 10 minutes, or greater than or equal to 20 minutes. Combinations of the above-referenced ranges are also possible (e.g., greater than or equal to 5 minutes and less than or equal to 30 minutes). Other ranges are also possible.

Apparatuses and apparatus components as described herein (e.g., a channel, an inlet, an outlet, a port, a collection chamber) may be made from any suitable materials. Non-limiting examples of suitable materials include polymers such as polycarbonate, high density polyethylene (HDPE), perfluoroalkoxy alkane (PFA) polymers, and nylon.

### Example 1

This example describes the design and operation of a device suitable for the filtration, washing, drying and dispensing of solids generated during chemical processing. This device may be particularly suited to, but not limited to, the processing of fine chemical chemicals including active pharmaceutical ingredients and other such compounds. The scale of operation for the device is also particularly suited to, but not limited to, small processing scales typically found in a laboratory or on a bench top. The device is appropriate for repetitive intermittent operation during continuous or flow processing of solid-liquid streams.

The device consists of a tube structure in which solid particle suspended in liquid (hereafter referred to as a ‘slurry’ or ‘slurries’) can be introduced. Within this tube structure the particles can be filtered from the mother liquor, washed using a washing solvent, dried or mostly dried, transferred within the tube and then dispensed—typically into a collection chamber fixed together with the tube structure. The tube structure and collection chamber can be connected to a vacuum source. The materials of construction for the device should be compatible with the mother liquor, washing solvent(s) and solids to be filtered, washed and dispensed.

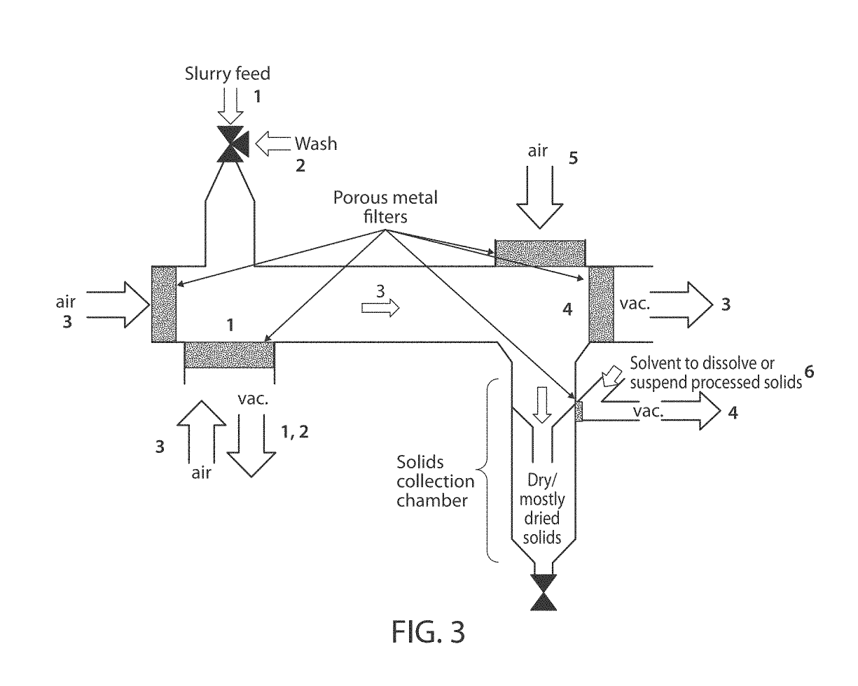

The invention may be suitable for filtering, washing, drying/mostly drying and dispensing solid particles from a slurry for intensified process streams that operate in flow or continuously. FIG. 3 gives a two-dimensional schematic description typical of the operation. The device may be operated in the following sequence:

(Step 1) A valve (optionally, a ball valve) is opened to allow a slurry to be fed into the tube-like chamber. The internal clearance within the valve may be sufficiently large such that solid bridging and blockages are avoided. The mother liquor of the slurry is filtered through a porous membrane or filter and drawn off using vacuum, leaving the solid particles behind on the filter.

(Step 2) A wash solvent is introduced into the chamber on top of the filtered solids in order to facilitate washing of the solids. The wash solvent is drawn off from the solids through the same porous filter as described in Step 1. The solid is dried within the chamber under vacuum.

(Step 3) Once the solid is dry or mostly dry, all valves connected to the openings on the chamber are closed. On the right hand side (RHS) of the chamber another vacuum line shielded by a porous filter is opened, evacuating a large proportion and in many cases most of the air from the chamber. This sets up the chamber for pneumatic transfer of the filtered, washed and dried/mostly dried solid. With the chamber under vacuum and the vacuum line pulling vacuum on the right hand side of the chamber, a valve is opened facilitating air pressure to flow into the tube like chamber from the left hand side (LHS). At the same time another valve is open beneath the solids filter also facilitating air pressure flow into the chamber back across the solids filter. The originally filtered, washed and mostly dry solids obstruct the path of the air flow into the chamber. When the air flow or pressure front is large enough entering on both the LHS of the chamber and beneath the solids filter, the obstructing solids are transferred to the RHS of the chamber in the direction of the vacuum being pulled.

(Step 4) Solids transferred in this way are stopped on the RHS of the chamber by the presence of a shielding porous filter on the vacuum line. The dry/mostly dry solids can be flushed from the RHS down and out of the chamber (typically into a collecting chamber). This is achieved by again closing all openings to the chamber and opening vacuum on another line connected to the collection chamber that is fixed together with the tube-like chamber.

(Step 5) Once the chamber is under vacuum, a valve is then opened releasing air from above the RHS of the chamber, down into the collection chamber. The air flow or pressure front released into the chamber in this way combined with gravity forces solids in the path of the air flow down into the collection chamber. Solids are collected into the collection chamber below continuously through a defined sequence of operation that repeats itself over and over until the entire solid to be processed has been collected in the collection chamber.

(Step 6) Solids are transferred out of the collection chamber again by introducing a solvent that can dissolve or suspend the solids so that they can be moved out of the system and onto the next stage in processing. The chamber could also be designed to dispense dry powder, e.g., by the addition of a rotatory valve or an auger screw could be on the base of the collection chamber that could be used to dispense the solid.

Several features that may be present in a suitable apparatus are listed below:

1. Controlled rate of transfer of slurries into the apparatus (may be achieved by pumping or regulation of vacuum);

2. Control of the concentration and direction of air flow into chamber during a de-vacuum step;

3. Ability to provide reverse airflow on a solids filter during a de-vacuum step;

4. Appropriate design geometry to remove/prevent dead air flow spaces during a de-vacuum step;

5. The presence of a recess filter within the apparatus to prevent overspill from a solids filter;

6. An internal geometry that does not restrict the transfer of a compressed cake to the opposite side of the chamber;

7. The production of a processed cake with <10 wt % moisture.

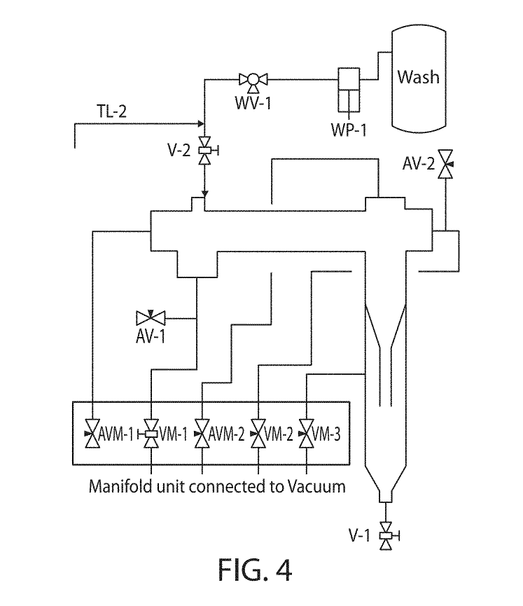

The filtration, washing, drying, transfer and collection/dispensation of a solid from a continuous intermittent stream of slurry can also be achieved. One such process is described in more detail below with reference to FIG. 4.

A summary of one exemplary sequence of operation for processing a single aliquot of slurry for the unit is as follows:

(Step 1) AVM-1 (air), AVM-2 (air) and VM-1 (vacuum) are opened.

(Step 2) V-2 is opened. An aliquot of slurry is transferred into the system by positive displacement of air into the buffer tank. Head pressure forces solid-liquid transfer via TL-1.

(Step 3) After the slurry has been filtered and the TL-2 line has been cleared, WV-1 and WP-1 are turned on to wash the filtered cake.

(Step 4) V-2 is closed AVM-1 and AVM-2 are closed.

(Step 5) VM-2 (vacuum) is opened and VM-1 is optionally closed. The filtered cake is dried under vacuum.

(Step 6) VM-1 is closed. AV-1 (air) and AVM-1 are opened for a short period and closed again. Rapid de-vacuum occurs and ambient air is released into the system. This causes the mostly dried cake to be transfered.

(Step 7) VM-3 (vacuum) is opened and VM-2 is closed.

(Step 8) AV-2 (air) and AVM-2 are opened for a short period and then closed again to transfer partially dried filter cake to the collection chamber.

At this point it is possible for a mostly dried cake to have been transferred to the collection chamber that is located beneath the apparatus and to which VM-3 is connected. The opening of AV-1 and AV-2 is may reverse the direction of air flow across the filters when air is released in the vacuumed chamber.

In one aspect, devices and methods described herein may address technological need of solid-liquid separation at small scales and/or during continuous manufacturing. Devices and methods may also be scaled for larger more intensified chemical processing requirements—e.g. miniplant scale. In one aspect, articles and methods described herein rely solely on the difference between vacuum and ambient pressures (˜14.7 psi) to move filtered solids pneumatically within the system.

The present invention may have immediate application in any field requiring the separation of solid and liquid phases. The technology may be suited to R&D laboratory scale processing or novel desktop scale processing, and could also be adapted to facilitate the processing of larger volumes for continuous manufacture in industries such as pharmaceuticals, foods, polymers, dyes, explosives, etc. It may be suited to areas of chemical synthesis that involve crystallization or solids precipitation or the use of solid catalysts or functionalized supports for reaction.

### Example 2

This example describes the use of an apparatus similar to that described in Example 1 in order to recover pharmaceuticals from slurries.

Fenofibrate, etomidate and ciprofloxacin hydrochloride were obtained from Xian Shunyi Bio-chemical Ltd. and used as received. ACS grade acetone and deionized water were used.

The apparatus (FWD unit) was designed and built in-house. The FWD unit and manifold was designed and 3D printed in nylon, which is compatible with many solvents. Initial prototype designs of the FWD unit were 3D printed in polycarbonate with a translucent finish. These prototypes allowed visual inspection of slurry flow and dried particle or cake flow within the FWD unit during testing.

The collection chamber was designed and fabricated in high density polyethylene (HDPE), which is also compatible with many solvents. A chemical duty dry diaphragm vacuum pump (Cole-palmer #EW-7900-62) was connected to a manifold and used to pull vacuum centrally at the manifold. Solenoid valves were used to control vacuum and to control the flow of air into the system. Automated ball valves (0.25″ diameter) were used to allow slurry to flow into the unit and to seal the system under vacuum. All fittings and connections were NPT type 1″, 0.25″ or 0.125″ and purchased from Swagelok. All perfluoroalkoxy alkane (PFA) and nylon tubing was purchased from McMaster-Carr. Power sources, Arduino Leonardo boards, relays, and wiring were purchased from either McMaster-Carr or Digikey.

From inception through to design, building and testing, a number of important parameters for effective operation were identified. During development of the system, 5 prototype designs were built, assembled and tested with improvements target after each iteration.

Controlling the initial flow rate at which the slurry (and wash solvent) entered the system and was positioned on the primary filter allowed for the slurry splashing to be reduced and/or prevented. The resistivity of both the filter and the solids cake formed from the initial slurry provided guidance as to what volume of slurry could be filtered at one pass (aliquot of slurry), and/or how much the primary filter could be recessed within the unit without overspilling of the slurry from the primary filter in the system.

Cake drying can be dependent upon heat and mass transfer. For the system demonstrated here, heat was not provided and vacuum alone was used dry the solids. However, heat could be used to assist with drying in other embodiments. In addition, the solids were typically washed with low boiling point (or high vapor pressure) solvents. Some slurries comprised large size particles that de-liquored well during filtration. The system can process small aliquots of slurry with solids mass ranging from 100 mg to 300 mg per aliquot on an intermittent and/or continuous basis.

Transfer of the dried cake was typically achieved once the slurry contained <10 wt % liquid. Sufficient concentration and appropriate direction of air flow was also achieved during de-vacuum and transfer of the dried cake. During the initial de-vacuum, the incoming ambient air pressure from the LHS of the chamber entered through nylon tubing with 0.29″ internal diameter at a height 0.125″ from the floor of the FWD unit. In addition, ambient air was also introduced at the same time from beneath the filter providing air flow back across the primary filter to displace dried solids into the air flow path moving simultaneously from LHS to RHS within the FWD unit during de-vacuum.

During testing, initial prototypes showed dead spaces for the air flow during the de-vacuum transfer step. Subsequent prototypes were designed which eliminated these dead spaces and allowed a flow path with equivalent compressed cake diameter for the transfer of compressed cake from LHS to the RHS of the chamber.

The system described in this example is capable of processing high value chemicals such as active pharmaceutical ingredients. As a demonstration, Fenofibrate (FEN) prepared in deionized water having a slurry density of 0.05 g/mL was processed using this system.

The homogeneously mixed FEN slurry was pumped into the chamber via TL-1 (with V-2 opened) at 180 mL/min, which resulted in the transfer of approximately 4 mL of slurry and 200 mg of Fenofibrate to the system. The water was filtered off from the crystalline solid particles under vacuum line VM-1 and noted to de-liquor rapidly. AVM-1 and AVM-2 are also open during this time to allow the air pressure above the solids filter within the FWD unit to be closer to ambient.

10 mL of water was then introduced as a wash solvent via WP-1 using WV-1 and wash tank and drawn off under vacuum (˜15 inches of Hg) using VM-1. The washed crystalline FEN particles were retained within the FWD unit on the primary filter above VM-1. Valves were closed on all openings to the chamber except for VM-2, drying the washed solid at 24 inches of Hg of vacuum for 3 minutes.

The valves at AVM-1 and AV-1 were then opened, allowing air to enter the chamber from the LHS transferring the dried solid FEN particles to the RHS of the chamber (the vacuum in the chamber dropped to 15 inches of Hg). Rapidly changing the vacuum in this way within the chamber was repeated twice more. A porous filter on the RHS of the unit prevented the particles from entering the VM-2 line. The solids that had not already fallen into the collection chamber below were dispensed by closing all openings except for VM-3 (connected to the collection chamber below). This increased the vacuum in the unit to 24 inches of Hg.

Then the valve at AVM-2 and AV-2 was opened, allowing air pressure to enter the chamber from above and transferring any loose FEN particles below to the collection chamber. This caused the vacuum in the chamber to again drop to 15 inches of Hg. A porous filter was also placed within the collection chamber to prevent particles entering the VM-3 line.

A homogeneous slurry of FEN in water was again introduced into the FWD unit via slurry line TL-2 as before, repeating the above vacuum and valve switching sequence. A batch of 100 mL of slurry (FEN in water) was processed in this way.

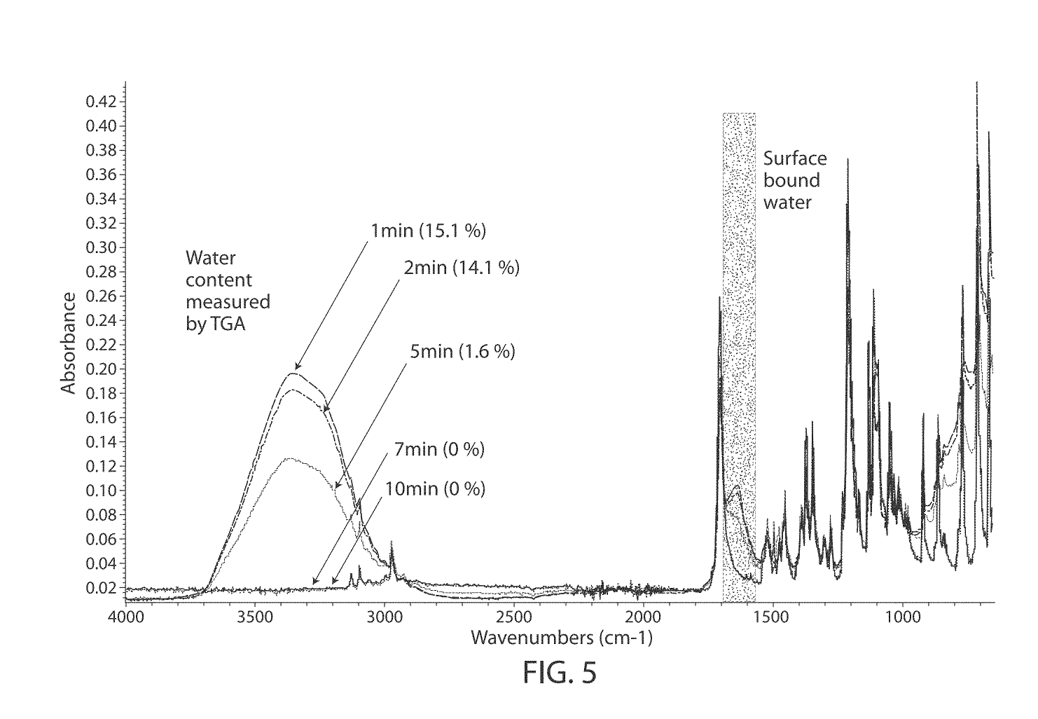

A slurry comprising the drug etomidate and water was also processed using the FWD. The mean particle size of the etomidate used was ˜100 microns; it also contained some fine particles. Etomidate was slower to filter and dry that the previously processed fenofibrate, so the time the filtered powdered cake spent drying on the filter at VM-1 after washing was measured and optimized in order to facilitate efficient transfer of filtered powder cake. Samples were taken during the filter dry time and analyzed for moisture content using thermogravimetric analysis (TGA) and Fourier Transform Infra-red (FTIR) spectroscopy. The results are presented in FIG. 5 and show that the solids were fully dried after a filter dry time of 7 mins. Once the appropriate dry time within the unit was established, a 20 mL aliquot of etomidate/water slurry was introduced in the FWD unit via TL-2. The same processing steps as described above for the processing of fenofibrate were followed. Filtered etomidate particles were washed with 30 mL of water and allowed to dry for 10 minutes within the FWD unit. During the de-vacuum step for dry cake transfer, both AV-1 and AVM-1 were open to transfer the dry cake to the other side of the unit. 3 grams of the drug etomidate in water (0.015 g/mL water) were processed continuously and intermittently using the FWD apparatus. Most of the etomidate solids processed with these parameters transferred within the FWD unit.

An FWD unit comprising a solids collection (CT) unit has also been designed to form part of a self-contained desktop-scale drug processing device.

Ciprofloxacin hydrochloride (the product) was crystallized from a continuous antisolvent crystallization process, where the product was solubilized in aqueous hydrochloric acid and crystallized by the addition of acetone. Acetone was also used as the wash solvent during processing within the FWD system. 30 mL slurry aliquots of crystallized product were processed within the FWD system at a time. The slurry aliquot was introduced to the FWD unit at a flow rate of 60 mL/min. The filtered cake was washed with 15 mL of acetone. The filtered and washed cake was allowed to dry under vacuum for 7 minutes. Cakes typically contained 5-8 wt % moisture (solvent) after the drying in place on the filter prior to transfer within the unit. Once all the cakes had been collected within the CT unit from test processing, an extra drying step was implemented. The CT unit was heated via an external electrical jacket to 40° C. under vacuum at 25 inches of Hg for 1 hour, after which the processed solids contained no remaining processing solvents. With time for FWD operation and cake drying taken into account, the FWD system operates to process ciprofloxacin hydrochloride with an overall continuous processing rate of 2 mL/min.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

Any terms as used herein related to shape, orientation, alignment, and/or geometric relationship of or between, for example, one or more articles, structures, forces, fields, flows, directions/trajectories, and/or subcomponents thereof and/or combinations thereof and/or any other tangible or intangible elements not listed above amenable to characterization by such terms, unless otherwise defined or indicated, shall be understood to not require absolute conformance to a mathematical definition of such term, but, rather, shall be understood to indicate conformance to the mathematical definition of such term to the extent possible for the subject matter so characterized as would be understood by one skilled in the art most closely related to such subject matter. Examples of such terms related to shape, orientation, and/or geometric relationship include, but are not limited to terms descriptive of: shape—such as, round, square, circular/circle, rectangular/rectangle, triangular/triangle, cylindrical/cylinder, elliptical/ellipse, (n)polygonal/(n)polygon, etc.; angular orientation—such as perpendicular, orthogonal, parallel, vertical, horizontal, collinear, etc.; contour and/or trajectory—such as, plane/planar, coplanar, hemispherical, semi-hemispherical, line/linear, hyperbolic, parabolic, flat, curved, straight, arcuate, sinusoidal, tangent/tangential, etc.; direction—such as, north, south, east, west, etc.; surface and/or bulk material properties and/or spatial/temporal resolution and/or distribution—such as, smooth, reflective, transparent, clear, opaque, rigid, impermeable, uniform(ly), inert, non-wettable, insoluble, steady, invariant, constant, homogeneous, etc.; as well as many others that would be apparent to those skilled in the relevant arts. As one example, a fabricated article that would described herein as being “square” would not require such article to have faces or sides that are perfectly planar or linear and that intersect at angles of exactly 90 degrees (indeed, such an article can only exist as a mathematical abstraction), but rather, the shape of such article should be interpreted as approximating a “square,” as defined mathematically, to an extent typically achievable and achieved for the recited fabrication technique as would be understood by those skilled in the art or as specifically described. As another example, two or more fabricated articles that would described herein as being “aligned” would not require such articles to have faces or sides that are perfectly aligned (indeed, such an article can only exist as a mathematical abstraction), but rather, the arrangement of such articles should be interpreted as approximating “aligned,” as defined mathematically, to an extent typically achievable and achieved for the recited fabrication technique as would be understood by those skilled in the art or as specifically described.

1. A method for at least partially separating liquid from solid in a slurry, comprising:
applying a reduced pressure to an upstream portion of a slurry, thereby reducing the liquid content of the upstream portion to at most 20 wt %, and
applying a pressure gradient across a region between the upstream portion and a downstream portion, thereby urging the slurry to flow in the downstream direction.

2. Apparatus for recovering a solid from a slurry, comprising:
a channel defining an upstream end and a downstream end, comprising an inlet for receiving a slurry, and an outlet positioned downstream of the inlet;
first and second ports associated with the channel, the first port upstream of the second, and the first and second ports constructed and arranged to apply a pressure differential between them thereby urging a slurry in the channel to flow in a downstream direction; and
a variable pressure port associated with the channel between the first and second ports, constructed and arranged to apply a reduced pressure to a slurry in the channel.

3. (canceled)

4. A method as in claim 2, wherein a reduced pressure is generated by exposure of the downstream end to a source of vacuum.

5. A method as in claim 2, wherein a positive pressure is generated by exposure of the upstream end to a source of gas.

6-8. (canceled)

9. A method as in claim 2, further comprising washing the slurry by exposing the slurry to a washing liquid.

10. A method as in claim 9, further comprising removing the washing liquid from the slurry.

11-14. (canceled)

15. A method as in claim 2, further comprising dissolving the slurry in a dissolving liquid.

16. A method as in claim 2, wherein a liquid is recovered as a product

17. A method as in claim 2, wherein a solid is recovered as a product.

18-21. (canceled)

22. An apparatus as in claim 1, wherein the apparatus further comprises a port constructed and arranged to apply a washing liquid to the slurry.

23. An apparatus as in claim 22, wherein the apparatus further comprises a filter constructed and arranged to remove the washing liquid from the slurry.

24-30. (canceled)

31. An apparatus as in claim 1, further comprising a collection chamber fluidically connected to the outlet.

32. An apparatus as in claim 31, wherein a second variable pressure port is associated with the collection chamber.

33. An apparatus as in claim 32, wherein the second variable pressure port can apply a reduced pressure to the collection chamber.

34-35. (canceled)

36. An apparatus as in claim 2, wherein the apparatus is configured to operate at miniplant scale.

37. (canceled)

38. An apparatus as in claim 1, wherein the apparatus is one portion of a continuous manufacturing system

39-41. (canceled)

42. A method as in claim 1, wherein the slurry contains a solid.

43-45. (canceled)

46. A method as in claim 42, wherein the slurry contains 5 wt %-30 wt % solids prior to applying the reduced pressure.

47. A method as in claim 42, wherein the slurry contains at most 10 wt % of the liquid after applying the reduced pressure.

48. (canceled)

49. A method as in claim 2, wherein the slurry comprises a liquid.

50-55. (canceled)
